(19) United States
(12) Patent Application Publication
(10) Pub. No.: US 2009/0307390 A1
(43) Pub. Date: Dec. 10, 2009

(54) ACCESS OF BUILT-IN PERIPHERAL COMPONENTS BY INTERNAL AND EXTERNAL BUS PATHWAYS

(75) Inventor: James D. Bennett, Hroznetin (CZ)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/182,651

(22) Filed: Jul. 30, 2008

Related U.S. Application Data
(60) Provisional application No. 61/058,703, filed on Jun. 4, 2008.

(51) Int. Cl. G06F 3/00; G06F 1/26

(52) U.S. Cl. 710/36; 713/300

(57) ABSTRACT

A computing network infrastructure supports access to built-in peripheral devices of a first computing device by a second computing device. Internal peripheral devices are communicatively coupled to internal processing circuitry (located in the first computing device), which supports access using an internal data bus. An external bus that provides data and power is used to provide access from the second computing device to the internal peripheral devices. Arbitration is provided for power and for data access. The internal peripheral devices may be accessed by the second computing device even when the first computing device is powered down or not in working condition. In one embodiment, the second computing device may access the internal peripheral devices through the same data bus that the internal processing circuitry uses.

### CROSS REFERENCES TO RELATED APPLICATIONS

The present application claims priority under 35 U.S.C. 119(e) to U.S. Provisional Application Ser. No. 61/058,703, filed Jun. 4, 2008, and having a common title with the present application, which is incorporated herein by reference in its entirety for all purposes.

The present application is a related to:

Utility application Ser. No. 12/______ filed on even date herewith, and entitled “INTERNAL STORAGE WITH LOCAL AND REMOTE ACCESS,” (BP7203), and

Utility application Ser. No. 12/______ filed on even date herewith, and entitled, “REMOTE ACCESS TO AN INTERNAL STORAGE COMPONENT OF AN ELECTRONIC DEVICE VIA AN EXTERNAL PORT” (BP7205).

### BACKGROUND

1. Technical Field

The present invention relates generally to electronic devices; and, more particularly, to electronic devices and computing devices that employs internal peripheral devices.

2. Related Art

Internal storage components are integral part of most present day electronic devices and computing devices. Electronic devices and computing devices that utilize at least one internal storage component include personal computers, notebook computers, tablet personal computers, set top boxes, video players, personal video recorders, televisions, palm PCs (Personal Computer), cell phones, PDAs (Personal Digital Assistants) and a variety of media players. Internal storage components that have permanent storage abilities come in many varieties, such as hard disk drives and flash memories.

Internal storage components have limited access, that is, they are accessed for reading and writing, typically only by internal processing circuitry of the electronic device or computing device. This limited accessibility restricts the internal storage components from being used when the device is powered down or not in a working condition. Even when they are in working condition and powered on, the limited accessibility of internal storage components and other restricts a user from quickly transferring data stored therein to another electronic device or computing device. For example, a user whose first notebook computer is not working, e.g., because it cannot be powered up, cannot access any data stored in it. One of the reasons is that the user is unable to access a hard disk drive that may be present in the first notebook computer. The user may not be able to continue his work using another personal computer or notebook computer unless the hard disk drive of the first computer is accessed by enabling the first notebook computer. The user would typically take the first notebook computer (that is not working) to a computer service center and have the hard disk drive removed and the contents transferred to a Compact Disc (CD), etc. The data recovery causes the user to lose valuable time and thus results in loss of business, work, and/or revenues.

Users sometimes transfer data from one computing device (that may not be operable) to another. One example of such transfer is when a user transfers hard disk drive contents from a personal computer to a notebook computer. Such transfer requires a removable storage device such as a pen drive, a CD (Compact Disc), a DVD (Digital Video Disc) or a portable hard disk drive that is large enough to handle the entire volume of the hard disk drive. Alternatively, the user may use a local area network connection to transfer the hard disk drive contents from one computer to another. A user that is not equipped with these facilities (memory stick, CD, LAN, etc.) or one who does not have enough time to take such measures would be unable to accomplish the data transfer.

Data transfer between computers/PCs/notebooks also requires application software to manage the data transfer between devices, and in particular, requires both computers to have applications that support the data transfer running. Also, sometimes, internal storage components of the computers are not compatible due to construct, size, or other characteristics. In addition, internal storage component drivers may not be available if the internal storage component is moved to a new device where the data is needed, and a custom designed internal storage component may not fit easily.

These and similar problems exist with respect to other computer peripheral devices that are inaccessible when a host computer is non-functional or powered down. These types of devices include, are but not limited to, computer mice, displays, keyboards, network interfaces, and other peripheral devices. These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram of a computing device that supports remote access to internal peripheral devices via a remote access port;

FIG. 2 is a schematic block diagram showing some of the components of the computing device of FIG. 1 that are involved in power and data arbitration necessary to manage access to an internal peripheral device;

FIG. 3 is a schematic block diagram illustrating the access of a CD-ROM/DVD drive of a first computing device by a remote device via a remote access USB port;

FIG. 4 is a schematic block diagram illustrating access of a video device in a computing device by a remote host via a remote access USB port;

FIG. 5 is a schematic block diagram illustrating an exemplary embodiment of FIG. 1 wherein a remote and the host computing device share the same data bus for exchange of data;

FIG. 6 is a schematic block diagram illustrating in detail the power and data arbitration that is used in FIG. 5;

FIG. 7 is a schematic block diagram of an electronic network infrastructure illustrating access provided to various internal peripheral devices of a notebook computer/computing device by different remote electronic device hosts that may want to chare certain internal peripherals available in the notebook computer;

FIG. 8 is a flow diagram illustrating the general functionality of a power supply arbitration circuitry built in accordance with the present invention. The operation begins at a block; and

FIG. 9 is a flow chart illustrating the general functionality of data arbitration circuitry built in accordance with the present invention.

### DETAILED DESCRIPTION OF THE DRAWINGS

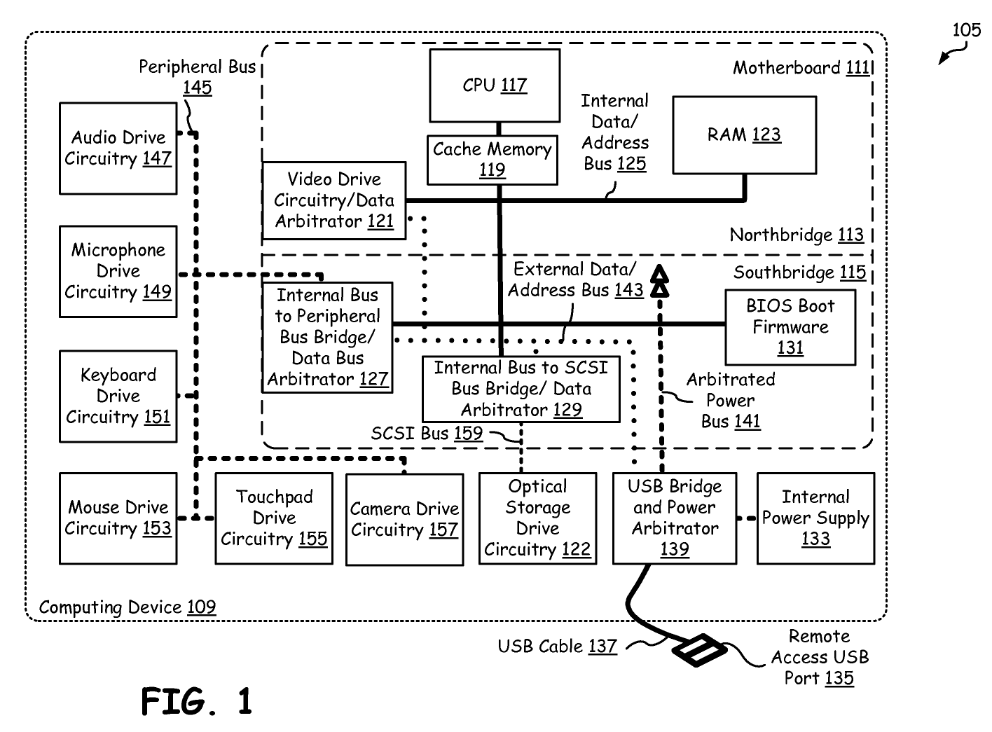

FIG. 1 is a schematic block diagram of a computing device 109 that supports remote access to internal peripheral devices via a remote access port 135. Internal peripheral devices in the computing device 109, such as a microphone, speakers, keyboard, mouse, etc. are controlled and managed by appropriate drive circuitry, such as video drive circuitry 121 for a video display, audio drive circuitry 147 for speakers, microphone drive circuitry 149 for a microphone, keyboard drive circuitry 151 for a keyboard, and mouse drive circuitry 153 for a mouse, touch drive circuitry 155 for a touchpad drive, camera drive circuitry 157 for a digital camera, and optical storage drive circuitry 122 for a coupled optical drive, etc. The drive circuitries can be accessed by an internal CPU 117 via an internal data/address bus 125, an internal bus to Small Computer User Interface (SCSI) bus bridge/data arbitrator 129, and/or an internal bus to peripheral bus bridge/data bus arbitrator 127. These internal peripherals devices utilize an internal power line 141 serviced by internal power supply 133 while facilitating access by the internal CPU 117.

An external electronic device connects to the computing device 109 using the remote access port 135, which may be a Universal Serial Bus (USB) port in some embodiments. The remote access port 135 (and other remote access ports) may be described herein as a USB port of the computing device 109. Internal to the computing device 109, a remote access USB cable 137 communicatively couples the remote access USB port 135 to a USB bridge and power arbitrator 139. The external electronic device (not shown) may power components of the computing device 109 via the remote access port 135 when accessing components of the computing device 109. During access by the external electronic device, components of the computing device 109 may alternatively be by the internal power supply 133.

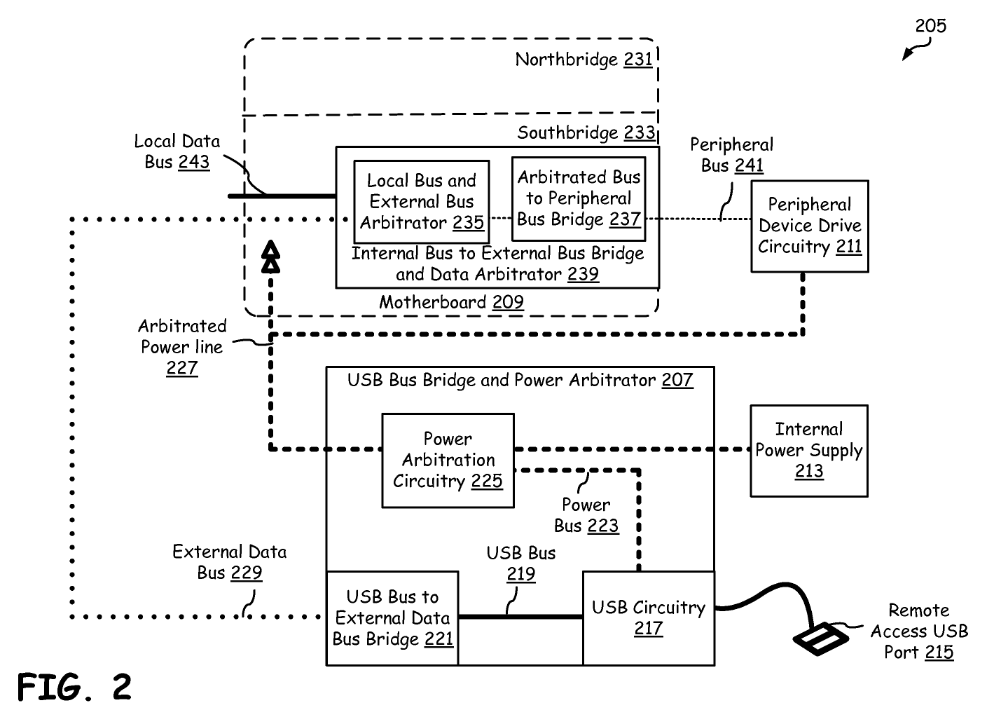

The USB bridge and power arbitrator 139 separates power line from data and supplies power either from the external electronic device (via the remote access USB port 135) or the power from a local internal power supply 133 to the internal peripheral devices via arbitrated power bus 141. Detailed description of this USB bridge and power arbitrator are made herein with reference to FIG. 2.

The internal peripheral devices (or their drive circuitry 147, 149, 151, 153) need access to be arbitrated as access requests can originate (simultaneously, overlapping, etc.) from the internal CPU 117 and the external electronic device. Arbitration for data/address is provided by an internal bus to peripheral bus bridge and data arbitrator 127 based upon a logic that incorporates priority, configuration, etc. Similarly, arbitration for power supply by the USB bridge and power arbitrator 139 based upon power supply availability and priority logic. More detailed description of the internal bus to peripheral bus bridge and data arbitrator 127 which arbitrates between internal data/address bus 125 and external data bus 143 can be found with reference to FIG. 2.

Typically, a computing device 109, such as a personal computer or a notebook computer, contains a motherboard 111 and a plurality of supported internal peripheral devices connected to the motherboard 111 via corresponding cables or wires. Supported devices may include keyboard, mouse, touchpad, CD-ROM drives, monitor, microphone, speakers, and camera. The monitor or the display unit is driven by a video drive circuitry and data arbitrator 121. The audio or the speakers are driven by the audio drive circuitry 147, a microphone is driven by microphone drive circuitry 149, keyboard is driven by keyboard drive circuitry 151, mouse is driven by mouse drive circuitry 153, touchpad is driven by touchpad drive circuitry 155, a camera is by camera drive circuitry 157 and optical storage device such as CD-ROM/RW or DVD ROM/RW is driven by optical storage drive circuitry 122. The motherboard 111 and the supported internal peripheral devices are powered by an internal power supply 133.

The motherboard 111 is generally divided into a Northbridge portion 113 and Southbridge portion 115. The Northbridge portion 113 contains the CPU 117, RAM (Random Access Memory) 123, cache memory 119, video drive circuitry and data arbitrator 121 with its local memory for video processing and clock generator (not shown), which are interconnected using an internal data/address bus 125 or other bus/line structures. Similarly, the Southbridge portion 115 contains various bridges, such as internal bus to internal peripheral bus bridge in internal bus to peripheral bus bridge/data arbitrator 127, LAN (Local Area Network) network bridge (not shown in figure), internal bus to SCSI (Small Computer System Interface) bus bridge in internal bus to SCSI bus bridge/data arbitrator 129 and USB bridge in USB bridge/power arbitrator 139, and BIOS (Basic Input-Output System) boot firmware 131, which are interconnected using the internal data/address bus 125 or other bus/line structures. The USB bridge and power arbitrator 139 bridges USB data bus within the USB cable 137 to external data/address bus 143, and powers the internal peripheral devices via a power line within the USB cable 137 or the internal power supply 133 based on preferences. The internal power supply 133 powers the motherboard via an internal arbitrated power bus structure 141. The internal arbitrated power bus 141 reaches each of the integrated circuitries as well as supported internal peripheral devices.

In accordance with the present invention, a remote access USB port 135 allows external electronic devices such as an external computer or a handheld device, to access the internal peripheral components through their corresponding drive circuitries via the remote access USB cable 137, USB bridge and power arbitrator 139, internal bus to peripheral bus bridge/data arbitrator 127 and arbitrated power bus 141. For devices that can not supply power via the external power bus in USB cable 137 through USB bridge and power arbitrator 139, the internal power arbitration circuitry (225 of FIG. 2) is employed to supply power through the internal power supply 133. The USB bridge and power arbitrator 139 can be present on the mother board 111 or can be outside the mother board in the form of a separate card. Internal bus to peripheral bus bridge/data arbitrator 127, bridges data from the internal bus to the peripheral bus. The peripheral bus could be the traditional EISA (Extended Industry Standard Architecture), the PCI (Peripheral Component Interconnect) bus or any other bus that supports the peripheral devices.

In one embodiment of the present invention, the internal peripheral device keyboard through the keyboard drive circuitry 151 allows access to an external electronic device via remote access USB port 135 even when the computing device 109 is powered down or not in working condition. In this embodiment, the keyboard drive circuitry 151 does not receive power from the internal power supply 133, and the internal data/address bus 125 is inactive. Arbitrator circuitries (refer to FIG. 2 for detailed description) built into the mother board 111 or circuitry on a separate card monitor and determine inactivity in the internal address/data bus 125 and internal power supply 133 and allow access to the external electronic device via external data/address bus 143 and external power line from the remote access USB port 135. The USB bridge and power arbitrator 139 bridges the external data/address bus to the remote access USB cable 137.

For example, a user whose first notebook computer is down (say, the first notebook computer is not powering up) with all its internal peripherals intact, is unable to access the any of the internal peripherals. Let's take the case of the keyboard. If the user wants to use this keyboard, but since it is integrated with the notebook computer, he can not take it out. If the user is unable to repair the notebook computer, he can still use the valuable integrated peripherals (e.g. here keyboard) by using a second computer as facilitated by the present invention. In accordance with the present invention, the user connects the second computer to the first notebook computer via a USB cable, i.e. communicatively coupling the USB port of the second computer to the remote access USB port 135 of the first computer. Then the user gets a message saying new hardware (here keyboard) found and the second computer auto configures the new hardware. Thus access is gained by the second computer to use this hardware (keyboard).

Another example is a user having a notebook pc with an older operating system but a good display and a camera, wherein the notebook pc has a problem or is not working properly at present. To take advantages of many features available in the notebook pc, the user may need to upgrade the existing operating system. If the user has another desktop system that lacks a good display and a camera, he should be able to use these components of the notebook pc. In accordance with present invention, the user can gain access to the display and camera of the notebook pc using the desktop computer which has the latest operating system, and use the peripherals in the notebook pc (such as the display, keyboard, and the camera) effectively. The user has to just connect the remote access USB port of the notebook pc to the desktop computer using a USB cable. The user gets a message about the internal peripherals of notebook computer and their status. Through software, the user can activate the required peripherals. The data and power arbitrations are conducted automatically in accordance with the present invention. Even when the notebook pc is powered off, the user can access the display and camera of the notebook pc.

In another example, the user having a video player that has a smaller display wants to use the display of a notebook pc for better clarity of viewing. The user just connects the remote access port of the notebook pc to the output port of the video player through a USB cable. The data and power arbitration are conducted automatically based on user defined rules and the user can view the video on the notebook pc display.

The computing device can be in a state identified by the set including being powered off, not in working condition, unable to reboot, partially operable etc. and the power arbitration and data access arbitration are supported, in accordance with the present invention, when an external computing device is communicatively coupled to the computing device via the remote access port 135 to which power is also delivered by the external computing device.

FIG. 2 is a schematic block diagram 205 showing some of the components of the computing device of FIG. 1 that are typically involved in power and data arbitration necessary to manage access to an internal peripheral device. A USB bus bridge and power arbitrator 207 (139 of FIG. 1) may exist separately as a card (a daughter board, etc.) and may be incorporated into the motherboard 209. The USB bus bridge and power arbitrator 207 includes USB circuitry 217, power arbitration circuitry 225, and a USB bus to external data bus bridge 221. The USB circuitry 217 separates a power bus 223 from the USB data bus 219 and provides it to the power arbitration circuitry 225. The USB bus to external data bus bridge 221 bridges the data from the local USB data bus 219 to the external data bus 229. The power arbitration circuitry 225 arbitrates power between the internal power supply 213 and the power from the external USB port supplied over the power bus 223 based on user preferences or certain criteria. The criteria, for example, could be, if the local power supply is off or unavailable due to some reason, power from the external USB port is chosen and is provided to the motherboard 209 and to internal peripheral device drive circuitry 211. The arbitrated power to the motherboard 209 and the internal peripheral device drive circuitry 211 reaches through an arbitrated power line 227. The external data bus 229 extends to the motherboard 209. A local data bus 243 and the external data bus 229 are arbitrated using a local bus and external bus arbitrator 235 and the arbitrated bus to the peripheral bus bridge 237 bridges the data from arbitrated bus to the peripheral bus 241. The peripheral bus 241 can be one of many types of standards based bus or a proprietary bus and couples to peripheral device drive circuitry 211. For example, it could be a SCSI bus, PCI (Peripheral Control Interface) bus, EISA (Extended Industry Standard Architecture) bus or other types of buses which connects the peripheral device with the motherboard. Note that the internal bus to external bus bridge and data arbitrator 230 is shown to reside on a Southbridge portion 233 of a mother board that also includes a Northbridge portion 231.

In other embodiments, the USB bus bridge and power arbitrator 207 of the present invention may include fewer or more components than are illustrated, as well as lesser or further functionality. The coupling card illustrated that couples the remote access USB port 215 to internal peripheral devices is meant to merely offer one example of possible functionality and construction in accordance with the present invention.

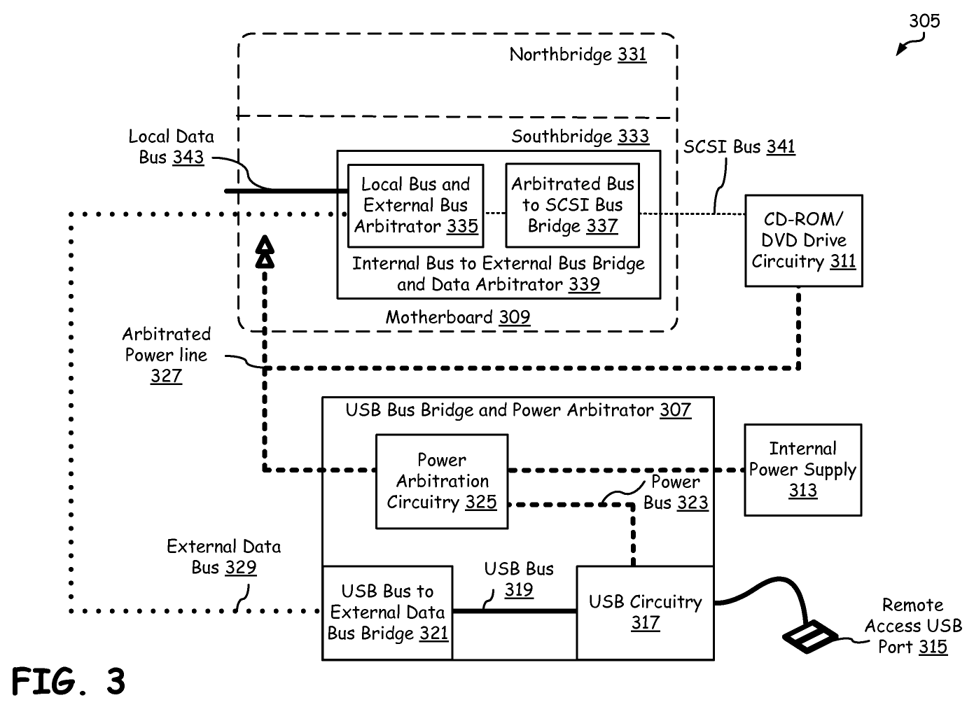

FIG. 3 is a schematic block diagram illustrating the access of a CD-ROM/DVD drive circuitry 311 in a first computing device by a remote host via a remote access USB port 315. The first computing device 305 includes a motherboard 309 and a USB bridge and power arbitrator 307 which can be on the motherboard 309 or can exist as a separate card, the peripheral CD/DVD drive circuitry 311 and an internal power source 313. The motherboard 309 includes a Northbridge portion 331 and a Southbridge portion 333. The USB bridge and power arbitrator 307 functions similar to the USB bridge and power arbitrator 207 of FIG. 2. USB circuitry 317 separates power bus 323 and USB bus 319 from the incoming remote access USB port 315. The power is arbitrated between the internal power bus 323 from the USB circuitry 317 and the internal power supply 313 based on priority and rules. For example, a rule could be-if the internal power supply is off, power from the USB circuitry is to be delivered, or if the USB power is not enough to drive the peripheral device, internal power supply is used. Rules can be any other user defined preferences.

The arbitrated power reaches the motherboard 309 and the CD/DVD drive circuitry 311 via arbitrated power line 327. A USB bus to external data bus bridge 321 bridges the data from the USB bus 319 to an external data bus 329. The internal bus to external bus bridge and data arbitrator 339 arbitrates between internal and external data buses and bridges data onto a SCSI bus 341 (for example, other buses that are used in CD/DVD drives are also contemplated) that reaches the CD/DVD drive circuitry 311. A local bus and external bus arbitrator 335 arbitrates between the local data bus 343 and the external data bus 329 based on whether the local CPU (117 of FIG. 1) accesses it or the remote host through remote access USB port 315 accesses it. The peripheral device, i.e. the CD-ROM/DVD drive circuitry 311 receives arbitrated data through the SCSI bus 341 from the arbitrated bus to SCSI bus bridge 337. The internal bus to external bus bridge and data arbitrator 239 is located on the Southbridge portion 333 of the motherboard.

In one exemplary scenario, the computing device (i.e. the host computer with the motherboard 309), is powered down (or disabled in some way) and the operating system is not working, while the CD/DVD drive circuitry is in good working condition. Without the benefit of the present invention, a user who wants to use the CD-ROM/DVD drive circuitry would have no option but to take this peripheral out of the device if it is detachable and use it in another remote host. This is a cumbersome task. In accordance to the present invention, without dismantling or opening up the host computer/computing device, the user can use the CD-ROM/DVD drive circuitry 311 just by connecting the remote access USB port 315 to a remote computer/remote electronic device that has its power turned on and is operational. The user simply connects a USB cable from the remote computer to the remote access USB port 315 of the host computer. Since the internal power supply 313 is down, power is supplied from the remote computer via the remote access USB port 315 and data access to the CD-ROM/DVD drive circuitry 311 is provided via the external data bus, through the internal bus to external bus bridge and data arbitrator 309.

In other embodiments, the USB bus bridge and power arbitrator 307 of the present invention may include fewer or more components than are illustrated as well as lesser or further functionality. In other words, the illustrated remote access provided from the remote access USB port 315 to the internal peripheral devices such as the CD-ROM/DVD drive circuitry 311 is meant to merely offer one example of possible functionality and construction in accordance with the present invention.

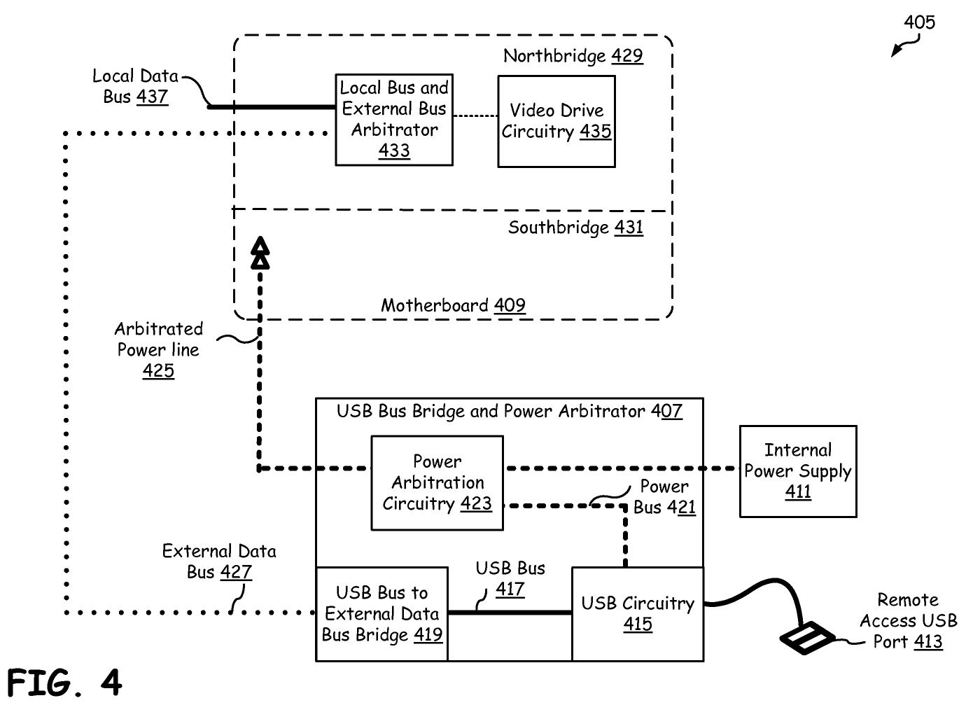

FIG. 4 is a schematic block diagram illustrating the access of a video device in a computing device by a remote host via a remote access USB port 413. The computing device includes a motherboard 409 having a Northbridge 429 and a Southbridge 431, in the particular embodiment, a USB bus bridge and power line arbitrator 407, and an internal power supply 411. The USB bus bridge and power line arbitrator 407 works similar to the USB bus bridge and power arbitrator 307 of the FIG. 3 and has USB circuitry 415 which separates data and power to a USB data bus 417 and a power bus 421. The USB bus to external data bus bridge 419 bridges data from the USB bus 417 to the external data bus 427. Power arbitration circuitry 423 arbitrates power delivery between the internal power supply 411 and the power from the remote access USB port 413 through the power bus 421 and delivers power to all the drive circuitries on the motherboard 409 via the arbitrated power line 425. A local bus and external bus arbitrator 433 located on the Northbridge 429 of the motherboard 409 arbitrates local data bus 437 and external data bus 427 from the USB bus bridge and power arbitrator 407, and the arbitrated data bus reaches the video drive circuitry 435. The video drive circuitry 435 receives data from the arbitrated data bus and receives power from the arbitrated power line 425. This video drive circuitry 435 drives a display device such as a CRT monitor or a LCD display device. To remotely access the display device of the computing device, power is delivered to the drive circuitry through the arbitrated power supply and data is communicated through the arbitrated data bus using a remote access USB port of the computing device.

In one exemplary scenario, a user wants to access a working display unit, such as an LCD display, of a nonfunctioning notebook computer, the LCD device represented as the video drive circuitry 435. In accordance with the present invention, the user can access the LCD display of the nonfunctioning notebook computer by connecting a USB cable to the remote access host of it to a working desktop computer. If the host power is down or host power is not available at the video drive circuitry 435, remote power from the desktop computer through the USB cable is delivered to the video drive circuitry 435 and the data from the USB cable is communicated to the video drive circuitry 435 through USB bus bridge and power arbitrator 407 and local bus and external bus arbitrator 433.

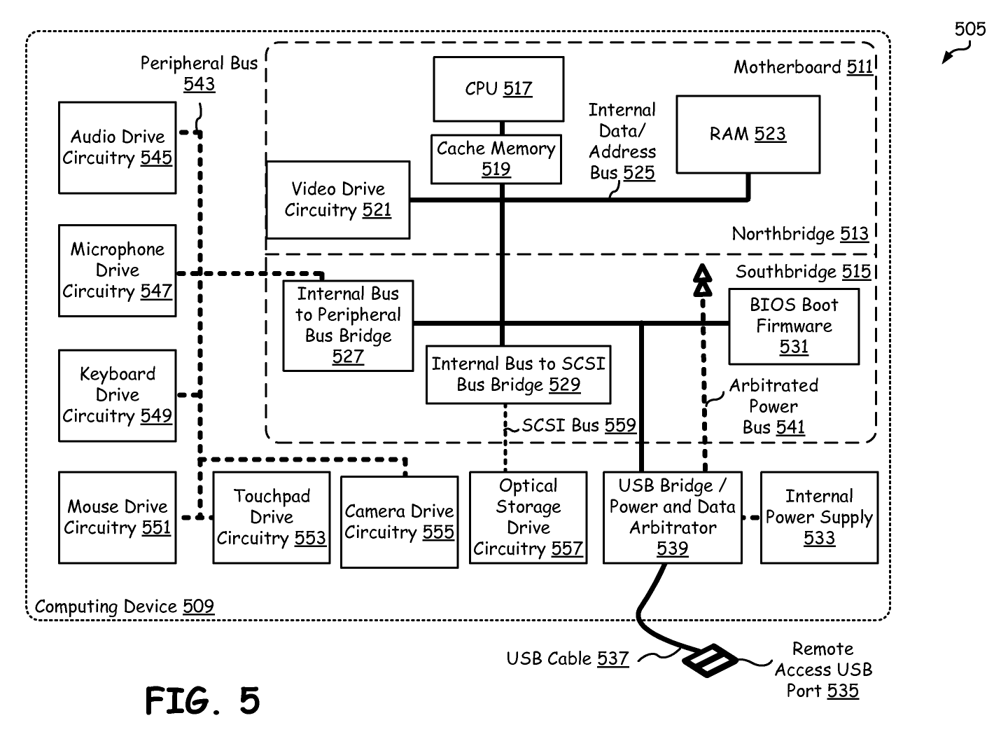

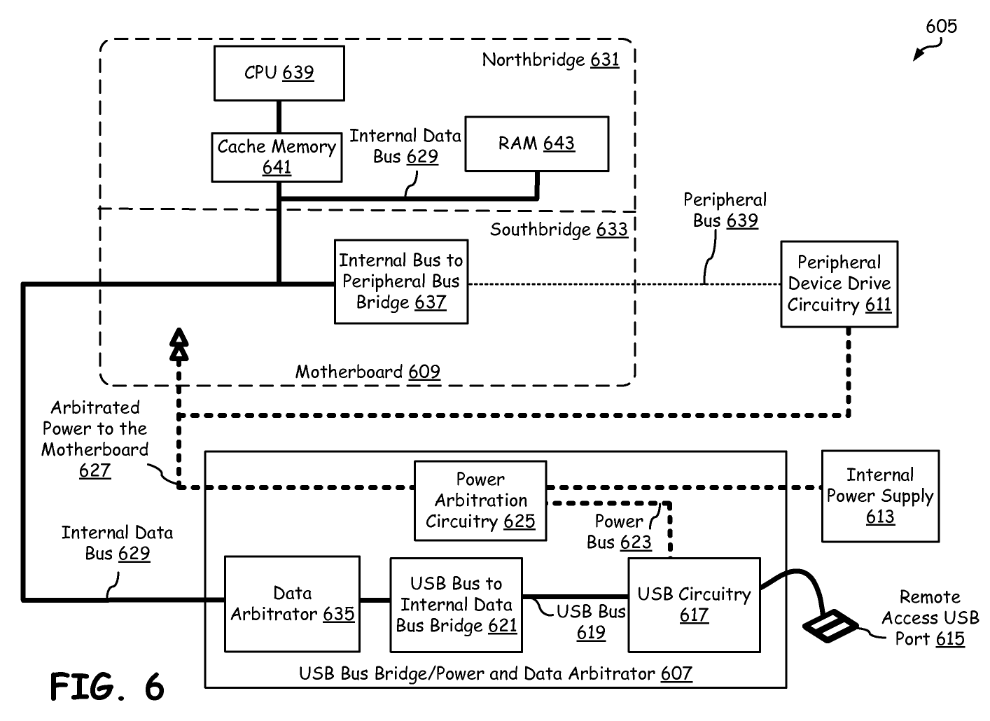

FIG. 5 is a schematic block diagram 505 illustrating another embodiment wherein a remote and the host computing device 509 share the same data bus for exchange of data. The computing device 509 includes a motherboard 511, an internal power supply 533, a USB bridge/power data arbitrator 539, and peripheral device drive circuitries, such as audio drive circuitry 545, microphone drive circuitry 547, keyboard drive circuitry 549, mouse drive circuitry 551, a drive circuitry 553 and camera drive circuitry 555 that are communicatively coupled to the motherboard 511 through a peripheral bus 543. An optical storage drive circuitry 557 is communicatively coupled to the motherboard 511 through the SCSI bus 559. A remote host accesses one of the internal peripheral device circuitries 545, 547, 549,551, 553, 555, 557 of this computing device 509 through the remote access USB port 535 attached to the USB cable 537. A USB bridge/power and data arbitrator 539, details of which are explained in FIG. 6, facilitates the power and data arbitration between the host computing device and the external computing device.

The motherboard 511 is generally divided into a Northbridge portion 513 and Southbridge portion 515. The Northbridge portion 513 contains the CPU 517, RAM (Random Access Memory) 523, cache memory 519, and video drive circuitry 521 with its local memory for video processing and clock generator (not shown), which are interconnected using an internal data/address bus 525 or other bus/line structures. Similarly, the Southbridge portion 515 contains various bridges, such as internal bus to peripheral bus bridge 527, LAN network bridge (not shown in figure), internal bus to SCSI bus bridge 529 and USB bridge in USB bridge/power and data arbitrator 539, and BIOS boot firmware 531, which are interconnected using the internal data/address bus 525 or other bus/line structures. The USB bridge/power and data arbitrator 539 (discussed in detail in FIG. 6) bridges USB data bus of the USB cable 537 to internal data/address bus 525, and powers the internal peripheral device drive circuitries via a power line within the USB cable 537 or the internal power supply 533 based on priorities and preferences. The internal power supply 533 powers the motherboard 511 via an internal arbitrated power bus structure 541. The internal arbitrated power bus 541 reaches each of the integrated circuitries as well as supported internal peripheral devices. The USB bridge/power and data arbitrator 539 could be located on the Southbridge portion 515 of motherboard 511 or can be in the form of a separate card.

In this embodiment, unlike the case in FIG. 1, only one address and data bus runs over the motherboard 511. The USB bridge/power and data arbitrator 539 arbitrates between the data from the external device through the remote access USB port 535 and the data from the internal bus and delivers to the internal peripheral devices through the internal bus to peripheral bus bridge 527. In this case, the complexity of having multiple address/data lines is reduced but additional intelligence is built into the USB bridge/power and data arbitrator 539 for data arbitration.

In one exemplary embodiment, a user whose first notebook computer is down (say, the first notebook computer that includes this invention features is not powering up) with all its internal peripherals working/intact, is unable to access any of the internal peripherals 545, 47, 549, 551, 553, 555, 557. For example, the keyboard is operational if powered. The user wants to use this keyboard, but since it is integrated with the notebook computer, he cannot take it out. If the user is unable to repair the notebook computer, he can still use the valuable integrated peripherals (e.g. here keyboard) by using second computer as per present invention. In accordance with the present invention, the user connects the second computer (remote computer) to the first notebook computer via a USB cable, i.e. communicatively coupling the USB port of the second computer to the remote access USB port 535 of the first computer. Then the user gets a message saying new hardware (here keyboard) found and the second computer auto configures the new hardware. Thus access is gained by the second computer to use this hardware (keyboard).

FIG. 6 is a schematic block diagram 605 illustrating in detail the power and data arbitration that is used in FIG. 5. The main circuitry includes a USB bus bridge/power and data arbitrator 607 communicatively coupled to the motherboard 609 and a peripheral device drive circuitry 611. A motherboard 609 has CPU 639 with cache memory 641, video drive circuitry, (not shown in figure) and RAM 643 in the Northbridge portion 631, and internal bus to peripheral bus bridge 637 in the Southbridge portion 633.

Remote access USB port 615 of the host couples data and power from the remote computing device to USB bus bridge/power arbitrator 607 of the through a USB cable. USB circuitry 617 separates the data bus (USB bus 619) and power bus (power bus 623) from the incoming data and power from the USB cable. Power from the internal power supply 613 and power bus 623 are arbitrated by power arbitration circuitry 625 and the arbitrated power is supplied to all components on the motherboard 609 and the peripheral device drive circuitry 611. The power arbitration can be based on certain user defined rules or certain priorities. For example the priority could be, if the host power is down, deliver the power from the external USB bus. A USB bus to internal data bus bridge 621 bridges data from the USB bus to the internal data bus. A data arbitrator 635 located in the USB bus bridge/power and data arbitrator 607, based on prior logic carries data from either the host CPU 639 or the remote computer CPU (not shown in figure) and delivers it to the desired internal peripheral device drive circuitry 611. If the host CPU is using the internal peripheral device, the data arbitrator 635 blocks data from the remote host and delivers it to the internal peripheral device through a internal bus to peripheral bus bridge 637. If the remote CPU (not shown in figure) from a remote host requests for the peripheral device to be used through the peripheral device drive circuitry 611, the data arbitrator disables the host CPU data and allows data flow from the remote CPU to the peripheral device drive circuitry 611 through internal bus to peripheral bus bridge 637.

In one exemplary embodiment, a user whose first notebook computer is down (say, the first notebook computer is not powering up) with all its internal peripherals intact, is unable to access the any of the internal peripherals. For example, if the camera must be used even when the notebook computer is inoperative, the present invention makes it possible. The user wants to use this camera when the notebook computer does not power up, but since it is integrated with the notebook computer, he can not take it out. If the user is unable to repair the notebook computer, he can still use the valuable integrated peripherals (e.g. here camera) by using second computer as per present invention. In accordance with the present invention, the user connects the second computer to the first notebook computer via a USB cable, i.e. communicatively coupling the USB port of the second computer to the remote access USB port 615 of the first computer. Since the host power is down, the power from external computer is delivered to the internal peripheral device drive circuitry (camera drive circuitry here) and the data arbitrator 635 uses data from the external USB port and delivers it to the internal peripheral device drive circuitry (camera drive circuitry here). The user gets a message saying new hardware (here camera) found and the second computer auto configures the new hardware. Thus access is gained by the second computer to use this hardware (camera).

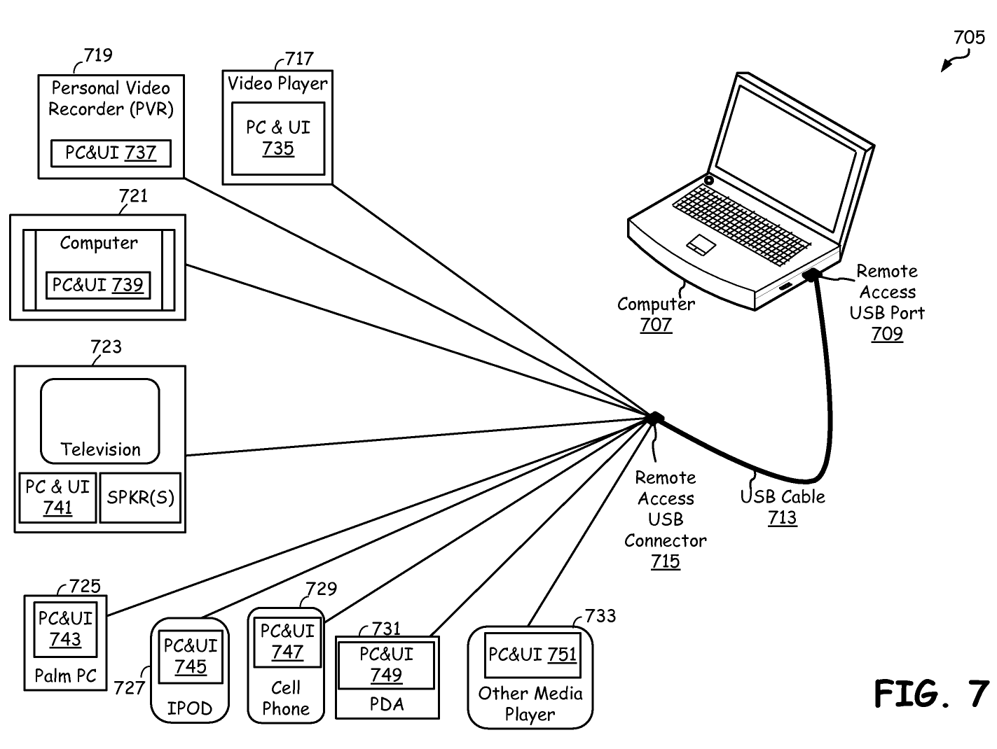

FIG. 7 is a schematic block diagram of an electronic network infrastructure 705 illustrating access provided to various internal peripheral devices of a notebook computer 707/computing device by different remote electronic device hosts that may want to chare certain internal peripherals available in the notebook computer 707. This electronic network infrastructure 705 includes the notebook computer 707 and several other electronic devices, but not limited to, a video player 717, a personal video recorder (PVR) 719, a computer 721, a television 723, a palm PC (Personal Computer) 725, an IPOD 727, a cell phone 729, a Personal Digital Assistant (PDA) 731 and any other media player 733. Each of these electronic devices 717 through 733 includes a corresponding peripheral circuitry and a user interface (PC & UI) 735 through 751. The peripheral circuitry keeps the functioning of the corresponding electronic device. The user interacts with these devices through the user interface. For example display is the user interface for the video player, keypads are user interface in cell phone, display, and speakers are user interface in television. In accordance with the present invention, any of the electronic devices can access the internal peripheral devices (in working condition) of the host computer whether it is powered on or off, or in working condition. The host computer may contain at least one USB port such as 709 to allow access to the electronic devices such as 717 through 733. The user connects a USB cable 713 from remote access USB port 709 of the computer 707 to the desired electronic device (through remote access USB connector 715 to the processing circuitry).

In one exemplary embodiment, a display on the video player 717 is not in working condition and a user wants to use the display of a remote notebook computer 707 to see the video. The user simply connects the remote access USB port to the processing circuitry of the video player through the USB connector. If the notebook computer 707 is down, power from the video player 717 is supplied to the video drive circuitry (not shown in figure) of the host computer and data from the video player is transferred to video drive circuitry. Now the video display (i.e. a display on the notebook computer 707) is functional and the remote video player 717 controls this through its control signals to the video drive circuitry and host CPU (not shown in figure).

In another exemplary embodiment, a user wants to send an SMS (Short Messaging Service) from the cell phone 729 finds it difficult to use a keypad provided with it. The user can access the keyboard and display monitor (in good working condition) of the notebook computer 707 from the cell phone 729 and send an SMS message comfortably whether or not the notebook computer 707 is powered on or off, or in working condition. The user simply connects the remote access USB port of the host computer to the processing circuitry of cell phone. The control circuitry (not shown in the figure) of the cell phone 729 upon the user request through a user interface, accesses the display device (monitor) and the keyboard of the notebook computer 707.

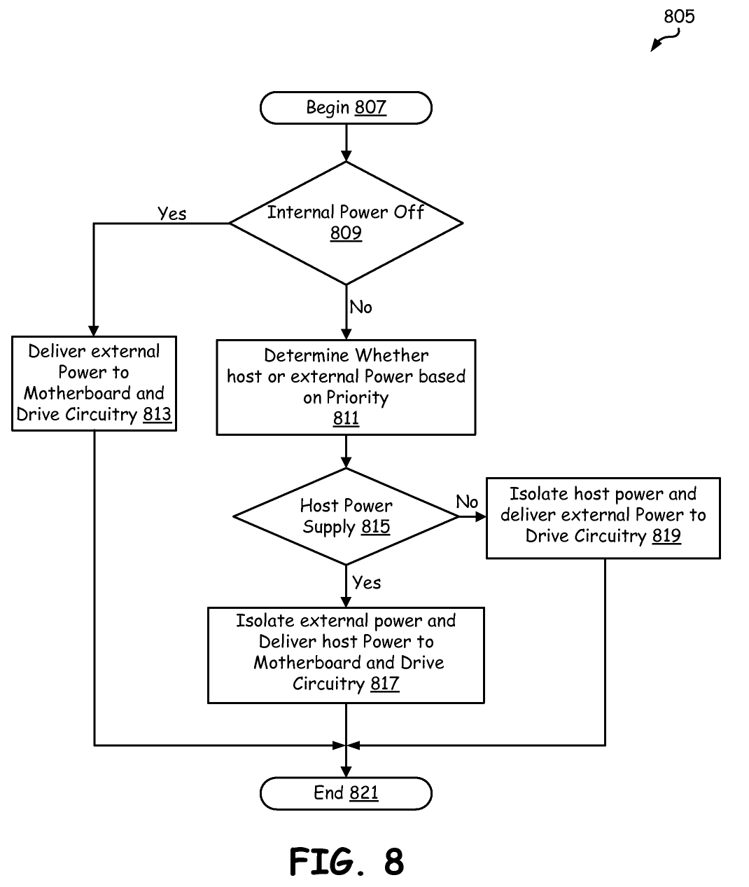

FIG. 8 is a flow diagram 805 illustrating the general functionality of a power supply arbitration circuitry built in accordance with the present invention. The operation begins at a block 807. At a next block 809, the power status of the computing device (or electronic device) is tested to see if its power is off (power off status) initially. If the computing device is powered off, then external power from the USB is delivered to the motherboard and the internal peripheral drive circuitry in the next block 813. But if the host power is on (i.e. not off), then the power arbitration circuitry, based on certain priorities, determines which power supply to be used in the block 811. This priority may be based upon, for example, the power supply arbitrator circuitry determining whether the computing device or electronic device is powered on using an internal battery. In such cases, the power supply arbitrator circuitry derives power from external power supply. On the contrary, if the computing device or electronic device is powered on from an alternating current socket, then the power supply arbitrator circuitry may derive power from internal power supply. In other words, the power management for the internal peripheral device is done by the power supply arbitrator circuitry based upon certain intelligent logic.

At the next block 815, this arbitration is tested for the host power supply. If the host power supply is the arbitrated power supply, then in the next block 817, external power supply is isolated and the host power supply is delivered to the motherboard and/or the peripheral device drive circuitry. If the host power is not sufficient, and the remote power supply is the arbitrated power supply, in block 819, host power is isolated and power from the remote USB port is delivered to the motherboard and/or the peripheral device drive circuitry. The process ends at the block 821 with the delivery of internal or external power to the peripheral device. Again the process begins when the host receives request for access of the internal peripheral device.

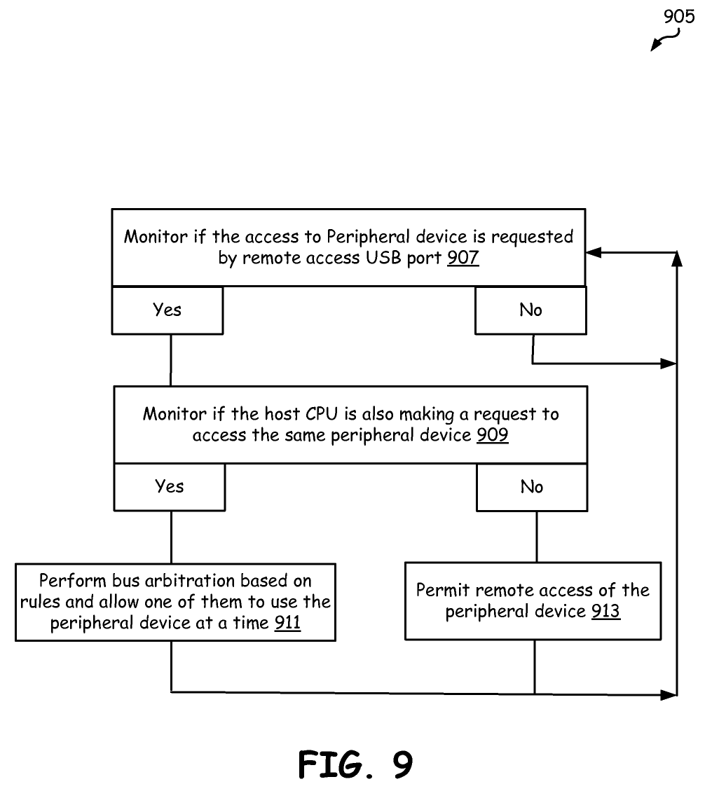

FIG. 9 is a flow chart 905 illustrating the general functionality of data arbitration circuitry built in accordance with the present invention. The operations begins at a block 907, as soon as a computing device or electronic device is powered on and an internal bus to peripheral bus bridge and data arbitrator circuitry in the computing device begins to monitor activity of two data buses, one internal to a motherboard of the computing device and the other an external bus from a remote access USB port of the computing device. If the access to a peripheral device in the computing device is requested from the remote access USB port, in the next block 909, the host CPU's request to the same peripheral device is monitored. Otherwise, monitoring access request to the peripheral device by remote access USB port is continued at the next block 907.

At the next block 911, if the host CPU is simultaneously also making request to access the same internal peripheral device at the same time, bus arbitration is performed based on arbitration logic, priorities and rules. Only one of them (host or remote host) is allowed to use the bus, one at a time. If the host CPU is not making any request at that time, then, at a next block 913, the access to internal peripheral device by the remote host is granted through the remote access USB port. Subsequently, access to internal peripheral device is requested by remote access USB port is monitored at the next block 907 and the process continues.

The logic for such arbitration, for example, may involve priority to internal processing circuitry under usual circumstances and priority to an external processing circuitry in other situations. In other words, during power up and other important internal peripheral device accesses, the priority might be for the internal processing circuitry. In other situations, such as using a built-in camera or speaker, the internal peripheral device bus arbitrator circuitry may arbitrate and multiplex time between the internal processing circuitry and external processing circuitry.

When both of the processing circuitries (internal or external) are not attempting to access simultaneously, such as when the external processing circuitry is not communicatively coupled to the internal peripheral device, the internal peripheral device bus arbitrator circuitry provides access to whichever processing circuitry that makes requests. However, when access request does not come from the host CPU via internal data bus, such as when the computing device or the electronic device is powered off or not in working condition, the internal peripheral device bus arbitrator circuitry provides access to the external processing circuitry, by drawing power via external power line.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A computing network infrastructure that supports a first computing device and a second computing device, the computing network infrastructure comprising:
first processing circuitry that is contained within the first computing device;
a plurality of internal peripheral devices communicatively coupled to the first processing circuitry via an internal data bus;
the first computing device supporting selective power delivery to the plurality of internal peripheral devices from an internal power source of the first computing device and an external power source associated with the second computing device via a data port disposed on the first computing device;
second processing circuitry that is contained within the second computing device; and
the second processing circuitry accessing at least one of the plurality of internal peripheral devices of the first computing device via at least the data port and an external data bus.

2. The computing network infrastructure of claim 1 further comprising a bus arbitrator that arbitrates and selectively permits access to the at least one of the plurality of internal peripheral devices to the first processing circuitry and the second processing circuitry.

3. The computing network infrastructure of claim 2 wherein the second processing circuitry accesses the at least one of the plurality of internal peripheral devices of the first computing device via the external data bus and the data port while the at least one of the plurality of internal peripheral devices of the first computing device are powered by the internal power source.

4. The computing network infrastructure of claim 2 wherein the second processing circuitry accesses the at least one of the plurality of internal peripheral devices of the first computing device via the external data bus and the data port while the at least one of the plurality of internal peripheral devices in the first computing device are powered by the external power source.

5. The computing network infrastructure of claim 2 further comprising power arbitration circuitry in the first computing device that arbitrates selective power supply of the at least one of the plurality of internal peripheral devices between the internal power source and the external power source based upon at least availability of power and priority rules.

6. The computing network infrastructure of claim 5 wherein the power arbitration circuitry arbitrates power delivery to the at least one of the plurality of internal peripheral devices when the first computing device is being supplied power from the internal power source and the external power source.

7. The computing network infrastructure of claim 1 wherein the second processing circuitry accesses the at least one of the plurality of internal peripheral devices of the first computing device via the external data bus and the data port while the at least one of the plurality of internal peripheral devices in the first computing device are powered by the external power source.

8. The computing network infrastructure of claim 5 wherein both the first processing circuitry and the second processing circuitry access the at least one of the plurality of internal peripheral devices of the first computing device, wherein access to the at least one of the plurality of internal peripheral devices is arbitrated by the bus arbitrator regardless of whether the power is supplied to the at least one of the plurality of internal peripheral devices by the internal power source or the external power source.

9. The computing network infrastructure of claim 5 wherein the data port is a Universal Serial Bus (USB) based data port and wherein the plurality of internal peripheral devices comprise one or more of an optical storage unit, a video display unit, a hard disk drive, and an integrated-circuit based non-volatile memory.

10. The computing network infrastructure of claim 2 wherein the bus arbitrator further arbitrates power supply to the at least one of the plurality of internal peripheral devices and wherein the second processing circuitry accesses the at least one of the plurality of internal peripheral devices when the first computing device is in a state identified by at least one of powered off, not in working condition, unable to reboot, and partially operable.

11. A computing device with a plurality of internal peripheral devices and an internal power supply, the computing device comprising:
a processing circuitry;
a data port for coupling data and power with an external device;
arbitrator circuitry that manages data access and power delivery to the plurality of internal peripheral devices; and
the arbitrator circuitry receiving power and a data access requests from the external device and arbitrating power delivery to the plurality of internal peripheral devices between the internal power supply and external power delivered via the data port; and
the arbitrator circuitry receiving power and the data access requests from the external device and arbitrating communication access to at least one of the plurality of internal peripheral devices between the processing circuitry and the external device via the data port.

12. The computing device of claim 11, wherein each of the plurality of internal peripheral devices comprises drive circuitry that communicatively couples to the arbitrator circuitry, receives inbound data and power from the arbitrator circuitry, and communicates outbound data to the processing circuitry and to the external device via the arbitrator circuitry.

13. The computing device of claim 11, wherein the data comprises at least one of data files, status codes, commands, instructions, priority data, and schedules.

14. The computing device of claim 11 wherein the data port is a Universal Serial Bus port.

15. The computing device of claim 11, further comprising:
an internal bus communicatively coupled to the arbitrator circuitry and to the internal peripheral devices, the arbitrator circuitry assigning for use the internal bus by either of the processing circuitry in the computing device or an external processing circuitry of the external device; and
the arbitrator circuitry enabling the first processing circuitry and the external processing circuitry in the external device to access the internal peripheral devices over the internal bus.

16. The computing device of claim 11, wherein the internal peripheral devices send data to and receive data from one of the first processing circuitry and the external processing circuitry at a time, with the arbitrator circuitry arbitrating data access by the first processing circuitry and the external processing circuitry, and further wherein the internal peripheral devices are supplied power that is arbitrated by the arbitrator circuitry between the internal power supply and external power delivered via the data port based upon availability of power and priority.

17. A method performed by a first computing device that includes first processing circuitry and an internal peripheral device and that is communicatively coupled to a second computing device that includes second processing circuitry, the method comprising:
monitoring data and power supplied by the second computing device via a data port disposed on the first computing device;
identifying a request to interact with the internal peripheral device from the second processing circuitry; and
arbitrating access to the internal peripheral device between the first processing circuitry and the second processing circuitry based upon priority rules.

18. The method performed of claim 17 further comprising:
determining availability of power from an internal power source; and
providing power to the internal peripheral device from either the internal power source or the data port.

19. The method of claim 18 wherein the first computing device provides power from the data port to the internal peripheral device when the internal power source is unavailable.

20. The method of claim 19 wherein the data port is based on Universal Serial Bus standards.
